(19) United States
(12) Patent Application Publication
(10) Pub. No.: US 2026/0307135 A1
(43) Pub. Date: Oct. 8, 2026

(54) METHOD FOR PRODUCING A WIRE PACKET FOR USE IN A WAVE WINDING MAT, WIRE PACKET FOR USE IN A WAVE WINDING MAT AND DEVICE FOR PRODUCING A WIRE PACKET FORMED FROM AT LEAST ONE FIRST BENT WIRE BLANK AND AT LEAST ONE SECOND BENT WIRE BLANK

(71) Applicant: Schaeffler Technolologies AG & Co. KG, Herzogenaurach (DE)

(72) Inventors: Matthias Friedmann, Bühl (DE); Fabrice Georg, Morschwiller (FR)

(73) Assignee: Schaeffler Technolologies AG & Co. KG, Herzogenaurach (DE)

(21) Appl. No.: 19/482,250

(22) PCT Filed: Apr. 18, 2024
(86) PCT No.: PCT/DE2024/100336

§ 371 Date: Nov. 7, 2025

(30) Foreign Application Priority Data
May 11, 2023 (DE) 10 2023 112 382.3

(51) Int. Cl. B21F 45/00; B21F 1/02; B21F 11/00

(52) U.S. Cl. CPC B21F 45/00; B21F 1/02; B21F 11/00

(57) ABSTRACT

A wire packet producing method using wire blanks including parallel first and second wire sections. The wire blanks includes bent transition/intermediate sections between the wire sections. The method includes withdrawing a first wire in the transition section length and a second wire section in a withdrawal direction. The first wire is straightened during withdrawal, forming a loop between the wire sections, offsetting the second wire section in an offset plane. The loop extends in the transition section region, providing a second wire withdrawing in the withdrawal direction. The second wire is straightened during withdrawal, guiding through the loop. The second wire is between the wire sections of the first wire, bending the second wire sections about a bending axis. The bending axis lies in the offset plane perpendicular to the withdrawal direction. The second wire sections are rolled about an axis parallel to the bending axis.

### CROSS REFERENCE TO RELATED APPLICATIONS

This application is the United States National Phase of PCT Appln. No. PCT/DE2024/100336 filed Apr. 18, 2024, which claims priority to German Application No. DE 10 2023 112 382.3, filed May 11, 2023, the entire disclosures of which are incorporated by reference herein.

### FIELD OF INVENTION

The present invention relates to a method for producing a wire packet for use in a wave winding mat, a wire packet for use in a wave winding mat and a device for producing a wire packet formed from at least a first wire blank bent in a U-shape and at least a second wire blank bent in a U-shape.

### BACKGROUND

Wire packets including wire blanks bent in a U-shape can be used for producing wave winding mats. These are used in rotors or stators of electric motors. Wave winding mats as a form of coil winding can be produced by winding individual wires in wire packets around a winding former. If the individual wires have a rectangular cross-section, then they are referred to as flat wire windings. Such a method results in a flat, wave-shaped coil winding, which is also referred to as a wave winding and has roof-shaped winding heads which are arranged in the course of the individual wires of the wave winding between two straight wire webs. During drawing into a rotor or stator with a cylindrical rotor or stator body, the wave winding with the individual wires lying one above the other is drawn in the region of the webs into grooves and the winding heads protrude axially beyond the rotor or stator body and form the offset of the individual wires via different grooves. Coil windings produced in this way allow coils of multiple electric circuits to be introduced into a stator or rotor body at once so that a three-phase operation of an electric motor is possible, for example. Therefore, the wire packets used may have a number of individual wires in a multiple of three. However, other constellations are also conceivable. It is also conceivable for the wave winding produced to not be drawn directly into a rotor or stator, but first into an insertion tool, which ultimately transfers the wave winding into a rotor or stator body. For the purpose of easier processing, it is advantageous if the wire blanks can be processed continuously and, in particular, if it is possible to avoid joining sections by means of welding.

From DE 10 2021 104 217 B4, a method for producing at least one U-shaped wire blank is known, with which method U-shaped wire blanks can be produced in a space-saving manner. However, this method does not make it possible to provide a winding with a layer exchange of the wires, which is required to build an electric machine that is as electromagnetically symmetrical as possible.

### SUMMARY

It is therefore an object of the present disclosure to provide a method for producing a wire packet for use in a wave winding mat, a wire packet for use in a wave winding mat, and a device for producing a wire packet formed from at least a first wire blank bent in a U-shape and at least a second wire blank bent in a U-shape, which does not have the disadvantages mentioned above.

This object is addressed by the subject matter of the independent patent claims.

Advantageous embodiments and further developments are the subject of the dependent claims, the accompanying description and the figures.

According to one aspect of the present disclosure, a method for producing at least a first wire blank bent in a U-shape and at least a second wire blank bent in a U-shape is provided. Both the first and second wire blanks include a first wire section and a second wire section. The second wire section runs parallel to the first wire section. The first wire blank also has a bent transition section located between the first and second wire sections. The second wire section has a bent intermediate section located between the first and second wire sections. The method sequence begins by providing at least a first wire from a wire supply. This wire supply can, for example, be provided in the form of a large roll. The first wire is withdrawn at least in the length of the transition section and the second wire section from the wire supply in a withdrawal direction. In the process, the first wire is straightened. This is important for the later arrangement of the individual wire in a wave winding mat in order to ensure a symmetrical winding pattern. Asymmetries could lead to undesirable effects in the magnetic field, which should be avoided. Then a loop is formed in the region between the first and second wire sections. This type of material reserve can prevent the wire thickness of the first wire from being changed when it is later moved and shifted. The loop also provides space for the second wire to be inserted in a flush manner. The second wire section is then moved in an offset plane parallel to the withdrawal direction. This forms the transition section between two later bending points between the first and second wire sections. In an embodiment, the offset position is offset with respect to the original position by two wire positions. The loop is now located within the transition section between the first and second wire sections. In the next step, at least a second wire is provided from the wire supply. This wire is also withdrawn, like the first wire, in the withdrawal direction at least in the length of the second wire section, wherein the wire is straightened during withdrawal. The second wire is then guided through the loop of the first wire, wherein the second wire is arranged in a wire position between the first wire section of the first wire and the second wire section of the first wire. The free wire position created by the movement of the second wire section of the first wire is thereby occupied by the second wire.

In an embodiment, the first wire with its second wire section is thus offset by two wire positions, which means that between the first and the second wire section there is an unoccupied wire position in which only the intermediate section is located. The loop is also located in the intermediate section. The second wire can now be inserted into the loop in the free wire position between the first and second wire section of the first wire or can be guided through it. The second wire sections of both wires are then bent about a bending axis. The bending takes place in the transition section of the first wire and in the intermediate section of the second wire. The bending axis lies in the offset plane and perpendicular to the withdrawal direction. The respective second wire section of both wires is rolled about an axis parallel to the bending axis during the withdrawal and remains rolled during the moving and bending. The length of the second wire section can be determined individually for each wire packet to be produced. The longer this second wire section is, the more base material is available for winding the wave winding mat later.

When moving the wire positions, in an embodiment, the movement in the offset plane and along a circular path of the two wire sections towards one another (shifting) prevents tensile or compressive forces from acting on the wire. A change in the wire thickness, which could result in instabilities occurring at these affected points, can thus be avoided. The loop provided in the transition region ensures that there is enough wire in the transition region to prevent pulling and thinning. The method can be repeated with a desired number of wires in order to obtain a wire packet that has the correct basic dimensions for a planned wave winding mat.

Multiple first and second wires may be used to produce a wire packet in each case. It can be varied in this regard whether all required first wires are first arranged in the device and then the second wires are added, or whether a first and a second wire are always inserted in an alternating manner.

The wire packet produced using this method now has two layers of wires. The winding heads of the first wire blanks jump over the winding heads of the second wire blanks so that two “roof rows” are formed, one consisting of winding heads of the first wire blanks and a second consisting of those of the second wire blanks.

It is also possible to utilize a different rhythm instead of the position change by two wire positions, resulting in a different pattern. As long as this pattern is symmetrical in the wire packets as a whole and is found as a recurring pattern in the wave winding mat, individual adjustments can be made to accommodate various wire position changes.

According to a further embodiment of the present disclosure, the first wire and the second wire are each cut after the wire length required for the wire blank has been withdrawn. This creates individual wires arranged next to one another. This arrangement in combination with the rolled-up second wire sections in the second wire store allows the method to be carried out in a space-saving manner. In addition, the entire method can be carried out using a wire supply that provides all the required wire.

According to a further embodiment of the present disclosure, after the moving and bending, the wire of the second wire section is unrolled and straightened so that the second wire section extends parallel to the first wire section over its length. In an embodiment, the second wire section is several times longer than the first wire section. This is advantageous for using the wire blank for winding a wave winding. The beginning is then formed by the first wire section and the second wire section is then continuously wound using a winding device so that it becomes part of a wave winding mat.

According to a further aspect of the present disclosure, a wire packet for use in a wave winding mat is provided. This includes at least a first and at least a second wire blank. The wave winding mat can be produced from the wire packet by continuous winding. The advantage of this design is that wire ends only protrude on one side of a wave winding mat, which ends must be welded and provided with connections and insulated. Only the beginning of the mat is pre-formed by bending the wire blanks, then it can be transferred to a winding device where the excess of the wire packets is wound into a wave winding mat.

In an embodiment, the wire packet of both wire blanks includes a multiple of three, for example 9 or 12 first and second wire blanks in each case, since this brings electromagnetic advantages during later use in an electric motor.

According to a further aspect of the present disclosure, a device is provided for producing a wire packet formed from at least a first wire blank bent in a U-shape and at least a second wire blank bent in a U-shape. This device has a wire supply for feeding at least a first wire and at least a second wire in a withdrawal direction. In addition, it has a first straightening device arranged downstream of the wire supply in the withdrawal direction for straightening the fed wires, which ensures that the wires are all straightened in a uniform manner. The device further includes a first wire store in which a first wire section of the first wire and a first wire section of the second wire are received, and a moving and bending device in which a transition section of the first wire and an intermediate section of the second wire are located. A forming device is used to form a loop of the first wire when it is in the moving and bending device. The forming device can, for example, be designed as a forming roller. The forming of the transition section of the first wire can be carried out by means of the device before the feeding of the second wire so that the forming of the loop and the movement of the second wire section, wherein the transition section is formed, are completed before the introduction of the second wire. In addition, the device includes a second wire store in which a second wire section of the first wire and a second wire section of the second wire are received. This second wire store is designed as a ring store in which the second wire sections can be wound up.

According to a further embodiment of the present disclosure, the moving and bending device has a first clamp for fixing the first wire section and has a second clamp for fixing the second wire section, wherein the second clamp is pivotable about a pivot axis lying perpendicular to the withdrawal direction and between the clamps and is movable parallel to the pivot axis, and the second wire store is pivotable about the pivot axis together with the clamp. By designing the moving and bending device with two clamps, the transition section between two bending points can be formed in a targeted manner.

According to a further development of the present disclosure, the moving and bending device has a bending blade which can be moved perpendicularly to the withdrawal direction and about which the second clamp of the moving and bending device is pivotable. This allows the wire blanks to maintain their bending in precisely defined dimensions when bent along a bending edge of the bending blade. This is advantageous in order to obtain a symmetrically constructed wire packet, the bending points of which have all been bent and formed in a uniform manner.

According to a further embodiment of the present disclosure, the moving and bending device is suitable for releasably fixing the first wires by means of the clamps during the forming of the loop with the forming device and the movement and for temporarily opening the clamps thereafter for the drawing in of the second wires. This means that the moving and bending device can be used for several processes. First, it is used to form the first wire and then to receive and form the second wire. It is conceivable to open and close the clamps in an alternating manner in order to draw in the second wire step by step, but it is also possible to open and close both clamps at the same time. It may be advantageous to provide grooves on the clamps so that the position of the wires is secured even further than just by clamping.

According to a further embodiment of the present disclosure, the second wire store is linearly movable against the withdrawal direction for removing the second wire section stored therein, wherein a second straightening device for the second wire store is provided for straightening the second wire section removed from the second wire store. This is used for the final production of the wire blanks, as the second wire sections that have yet to be rolled are then drawn out and straightened and are arranged in their final position parallel to the first wire sections.

Further features, details and advantages of the present disclosure result from the wording of the claims and from the following description of exemplary embodiments based on the drawing.

### BRIEF DESCRIPTION OF THE DRAWINGS

In the drawings:

FIG. 1a and b: show a schematic representation of the configuration of multiple first wires extending parallel to one another in a device after drawing from a wire supply in a side view and a plan view;

FIG. 2: shows a schematic representation of the moving and bending device after the moving step in a plan view;

FIG. 3: shows a schematic representation of the moving and bending device after the introduction step in a plan view;

FIG. 4: shows a schematic representation of the moving and bending device after the bending step in a side view;

FIG. 5: shows a schematic representation of the moving and bending device after the production of multiple first and second U-shaped wire blanks extending parallel to one another in a side view; and

FIG. 6: shows a schematic representation of a wire packet.

### DETAILED DESCRIPTION

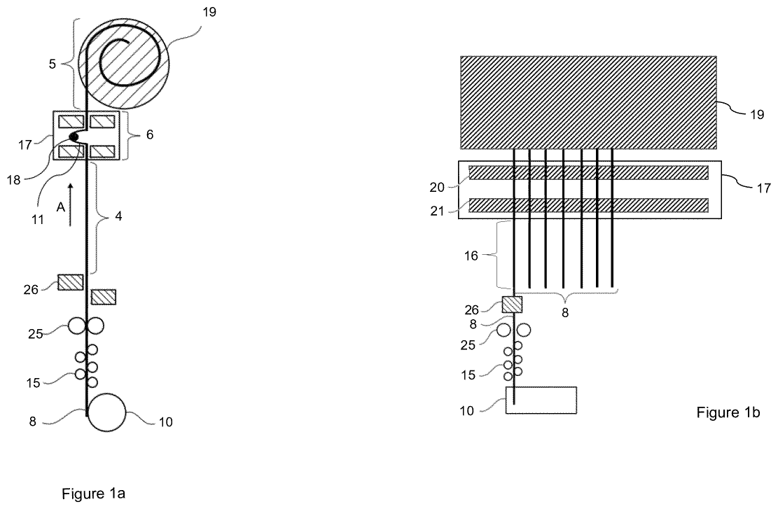

FIGS. 1a and 1b show a schematic representation of the configuration of multiple wires 8 extending parallel to one another in the device after drawing from the wire supply 10 in a side view and a plan view. The first wire 8 is withdrawn and unrolled from the wire supply 10 in a withdrawal direction A with the aid of a feed unit 25. It is straightened by means of a first straightening device 15. This is important to ensure a uniform shape in the wire packet 1 later. The first wire 8 has a first wire section 4 and a second wire section 5, between which there is a transition section 6. The second wire section 5 is rolled up in the desired final length in a second wire store 19 when the first wire 8 is withdrawn. The wire 8 is guided through a moving and bending device 17, where a loop 11 is formed in the transition section 6 by means of a forming device 18. After this process is complete, the first wire 8 can be cut using scissors 26. The process is then repeated for a desired number of times, wherein each subsequent first wire 8 is drawn into a first wire store 16, offset by two wire positions and parallel to the others, so that gaps are created between the individual wires 8. The first wires 8 are held in the moving and bending device between a first clamp 20 and a second clamp 21. This ensures that the predetermined wire position is maintained. This is particularly important for the process of forming the loop 11, which is carried out between the clamps 20, 21.

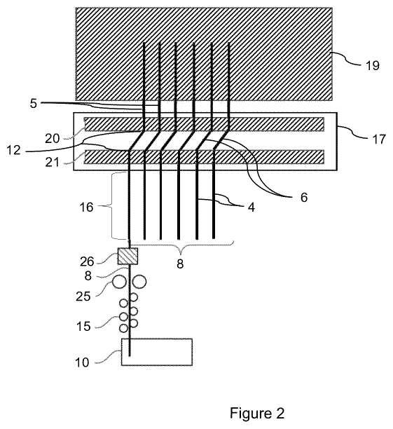

FIG. 2 shows a schematic representation of the moving and bending device 17 after the moving step in a plan view. In each case, the first clamp 21 holds the first wire section 4, while the second clamp 20 holds the second wire section 5 of the first wires 8. The clamps 20 are moved in an offset plane so that the respective second wire section 5 of the first wires 8 is arranged perpendicular to the withdrawal direction A by two wire positions from its corresponding first wire section 4. The clamp 20 can also be moved simultaneously in the opposite direction to the withdrawal direction A so that a circular movement is carried out. This prevents the wire thickness from changing during movement. It is also conceivable that both clamps 20, 21 are moved. The movement also leads to the formation of bending points 12, which limit the transition section 6. However, it is also possible to skip more than two wire positions in order to create other patterns. In this context, the second wire section 5 remains rolled up in the second wire store 19. This saves space when carrying out the method compared to unrolled wires.

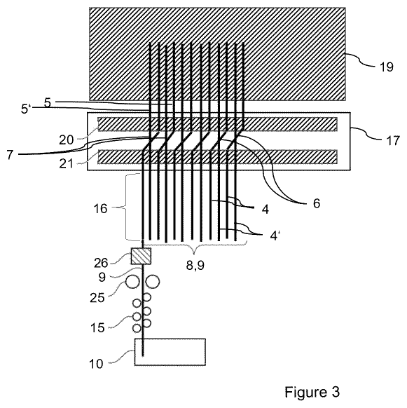

FIG. 3 shows a schematic representation of the moving and bending device after the introduction step in a plan view. After the first wires 8 have been arranged in the manner shown in FIG. 2, the second wires 9 are withdrawn and introduced. For this purpose, a second wire 9 is withdrawn, in each case, from the wire supply 10 one after the other. As with the first wires 8, this is achieved by means of the feed unit 25. The second wire 9 is also straightened by means of the first straightening device 15. The second wire 9 is guided through the loop 11 into the free wire position between the first wire section 4 and the second wire section 5 of the first wire 8. As a result, the intermediate section 7 of the second wire lies on the transition section 6 of the first wire 8. The first wire sections 4,4′ of the first and second wires 8, 9 are held in the first wire store 16, while the second wire sections 5, 5′ are held in the second wire store 19. The clamps 20, 21 of the moving and bending device 17 are suitable for subsequently also fixing the second wire 9. As soon as the second wire 9 has been drawn out to the desired length and arranged in the device, it can be cut from the wire supply 10 using the scissors 26.

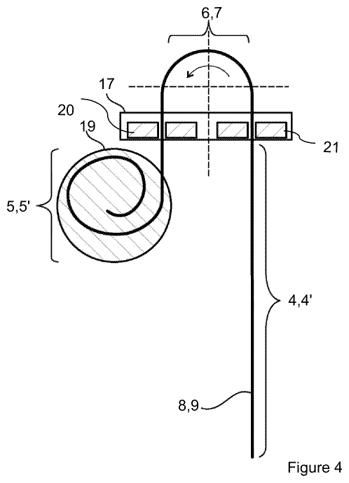

FIG. 4 shows a schematic representation of the moving and bending device 17 after the bending step in a side view. The first clamp 20 has been pivoted by 180° against the withdrawal direction A and is now opposite the second clamp 21. As a result, the first and second wires 8, 9 fixed in the moving and bending device 17 are bent together in the region of their transition or intermediate sections 6, 7. The first wire sections 4, 4′ are now arranged opposite the second wire sections 5, 5′, which are still rolled up in the second wire store 19.

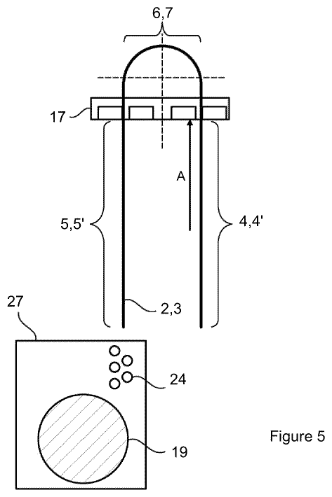

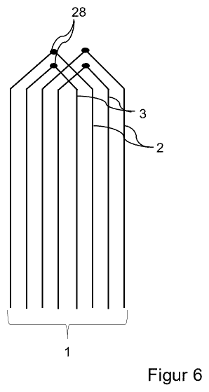

FIG. 5 shows a schematic representation of the moving and bending device 17 after the production of multiple first and second U-shaped wire blanks 2, 3 extending parallel to one another in a side view. The second wire store 10 was transferred to a linearly movable carriage 27. A second straightening device 24 is arranged on this. The second wire store 19 is moved by means of the carriage 27 opposite to the withdrawal direction A, wherein the rolled-up second wire sections 5, 5′ are unrolled and also straightened by the second straightening device 24. If the clamps 20, 21 of the moving and bending device 17 are now released, the finished wire blanks 2, 3 now present in a wire packet 1 can be removed. The wire packet 1, which is shown schematically in FIG. 6, can then be further processed or stored. The first and second wire blanks 2, 3 each have winding heads 28 which were created as a result of the bending process. It can be seen that the second wire blanks 3 extend offset from the first wire blanks 2 and the winding heads 28 of the first wire blanks 2 are arranged above those of the second wire blanks 3. This arrangement is electromagnetically symmetrical and advantageous for later use as a wave winding mat.

### LIST OF REFERENCE SIGNS

1 Wire packet
2 First wire blank
3 Second wire blank
4, 4′ First wire section
5 5′ Second wire section
6 Transition section
7 Intermediate section
8 First wire
9 Second wire
10 Wire supply
11 Loop
12 Bending points
15 First straightening device
16 First wire store
17 Moving and bending device
18 Forming device
19 Second wire store
20 First clamp
21 Second clamp
24 Second straightening device
25 Feed unit
26 Scissors
27 Carriage
28 Winding head
A Withdrawal direction

1. A method for producing a wire packet for use in a wave winding mat, which wire packet is formed from at least a first wire blank bent in a U-shape and at least a second wire blank bent in a U-shape, wherein both wire blanks comprise a first wire section and a second wire section running parallel to the first wire section, wherein the first wire blank comprises a bent transition section between the first wire section and the second wire section, and wherein the second wire blank comprises a bent intermediate section between the first wire section and the second wire section, the method comprising:
providing at least a first wire from a wire supply;
withdrawing the first wire at least in a length of the transition section and the second wire section in a withdrawal direction, wherein the first wire is straightened during withdrawal;
forming a loop in a region between the first wire section and the second wire section;
moving the second wire section parallel to the withdrawal direction in an offset plane by at least two wire positions, whereby the transition section is formed between two bending points between the first wire section and the second wire section, wherein the loop extends in a region of the transition section;
providing at least a second wire from the wire supply;
withdrawing the second wire at least in a length of the second wire section in the withdrawal direction, wherein the second wire is straightened during withdrawal;
inserting the second wire into or guiding the second wire through the loop of the first wire, wherein the second wire is arranged in a wire position between the first wire section of the first wire and the second wire section of the first wire;
bending the second wire sections about a bending axis, wherein the bending takes place in the transition section of the first wire and in the intermediate section of the second wire and the bending axis lies in the offset plane and perpendicular to the withdrawal direction;
wherein the second wire sections are rolled about an axis parallel to the bending axis during the withdrawal and remain rolled during the moving and bending.

2. The method according to claim 2, having the method step of: cutting the wires after withdrawing the length of wire required for the first and second wire blanks.

3. The method according to claim 1, wherein after the moving and bending, the wires of the second wire sections are unrolled and straightened so that the second wire sections extend parallel to the first wire sections over the length thereof.

4. A wire packet for use in a wave winding mat, which is produced by the method according to claim 1.

5. A device for producing a wire packet formed from at least a first wire blank bent in a U-shape and at least a second wire blank bent in a U-shape, having
a wire supply for feeding at least a first wire and at least a second wire in a withdrawal direction,
a first straightening device arranged downstream of the wire supply in the withdrawal direction for straightening the fed wires,
a first wire store in which a first wire section of the first wire and a first wire section of the second wire are received,
a moving and bending device in which a transition section of the first wire and an intermediate section of the second wire are located,
a forming device for forming a loop of the first wire,
a second wire store in which a second wire section of the first wire and a second wire section of the second wire are received, wherein the second wire store is a ring store in which the second wire sections of the first and second wires are wound up and wherein the forming of the transition section of the first wire is carried out before the feeding of the second wire.

6. The device according to claim 5, wherein the moving and bending device has a first clamp for fixing the first wire section and has a second clamp for fixing the second wire section, wherein the second clamp is pivotable about a pivot axis lying perpendicular to the withdrawal direction and between the clamps and is movable parallel to the pivot axis, and wherein the second wire store is pivotable about the pivot axis together with the second clamp.

7. The device according to claim 6, wherein the moving and bending device has a leg and a bending blade which is movable perpendicularly to the withdrawal direction and about which the leg of the moving and bending device is pivotable.

8. The device according to claim 6, wherein the moving and bending device allows for releasably fixing the first wires by the first and second clamps during the loop forming with the forming device and the movement and for temporarily opening the first and second clamps thereafter for the feeding of the second wires.

9. The device according to claim 6, wherein the second wire store is linearly movable against the withdrawal direction for removing the second wire section stored therein, and wherein the device further comprises a second straightening device for the second wire store for straightening the second wire section removed from the second wire store.
